(19) United States
(12) Patent Application Publication
(10) Pub. No.: US 2025/0323307 A1
(43) Pub. Date: Oct. 16, 2025

(54) SECONDARY BATTERY

(71) Applicant: Samsung SDI Co., Ltd., Yongin-si (KR)

(72) Inventors: Joung Ku KIM, Yongin-si (KR); Jung Hyun KIM, Yongin-si (KR); Jung Hyun PARK, Yongin-si (KR); Dong Sub LEE, Yongin-si (KR); Bong Geun KANG, Yongin-si (KR)

(21) Appl. No.: 18/999,876

(22) Filed: Dec. 23, 2024

(30) Foreign Application Priority Data
Apr. 15, 2024 (KR) 10-2024-0049803

(51) Int. Cl. H01M 10/04

(52) U.S. Cl. CPC H01M 10/0431

(57) ABSTRACT

One or more embodiments relates to a secondary battery capable of suppressing internal stress of the side of the electrode assembly, and capable of ensuring internal space of a case. The secondary battery according to one or more embodiments includes a case defining a space therein, an electrode assembly in the case and including a positive electrode plate, a negative electrode plate, and a separator wound in a cylindrical shape, and an adhesive part adhering and fixing a winding end of an outermost surface of the electrode assembly, and a cap assembly sealing the case.

### CROSS-REFERENCE TO RELATED APPLICATION

The present application claims priority to and the benefit of Korean Patent Application No. 10-2024-0049803, filed on Apr. 15, 2024, in the Korean Intellectual Property Office, the entire disclosure of which is incorporated herein by reference.

### BACKGROUND

### 1. Field

Embodiments relate to a secondary battery.

### 2. Description of the Related Art

In general, a secondary battery includes an electrode assembly, a case, and a cap assembly. The electrode assembly may have a cylindrical shape. The case has a cylindrical shape, and may accommodate the electrode assembly and an electrolyte. The cap assembly may be coupled to the upper opening of the case to seal the case. The cap assembly may allow a current generated from the electrode assembly to flow to an external device.

The electrode assembly includes a positive electrode plate, a negative electrode plate, and a separator. The separator is located between the positive electrode plate and the negative electrode plate. The electrode assembly is formed by winding the positive electrode plate, the negative electrode plate, and the separator. The electrode assembly is formed in a cylindrical shape. The end of the electrode assembly is fixed with a sealing tape. The winding end of the electrode assembly is not unwound.

The information disclosed in this section is provided only for enhancement of understanding of the background of the disclosure and therefore it may contain information that does not form the prior art.

### SUMMARY

One or more embodiments relate to a secondary battery capable of suppressing internal stress of the side of the electrode assembly, and capable of ensuring internal space of a case

The secondary battery according to one or more embodiments includes a case defining a space therein, an electrode assembly in the case and including a positive electrode plate, a negative electrode plate, and a separator wound in a cylindrical shape, and an adhesive part adhering and fixing a winding end of an outermost surface of the electrode assembly, and a cap assembly sealing the case.

The adhesive part may be along a boundary line of the winding end.

The adhesive part may include patterns spaced apart or a continuous pattern.

The separator may be at an outermost part of the electrode assembly, wherein the adhesive part is along an end of the separator.

The adhesive part may include patterns at equal intervals.

The adhesive part may include patterns with a same length.

The adhesive part may be fixed to the outermost surface by fusion or bonding.

The adhesive part may be fixed to the outermost surface by heat fusion.

The adhesive part may include first adhesive parts respectively at a top and at a bottom of the electrode assembly, and a second adhesive part between the first adhesive parts.

The second adhesive part may extend along an extending direction of the winding end, wherein the second adhesive part is in a same direction as the first adhesive parts, or in a direction substantially perpendicular to the first adhesive parts.

### BRIEF DESCRIPTION OF THE DRAWINGS

The accompanying drawings, which are incorporated in this specification, illustrate embodiments, and serve to further illustrate the technical ideas of the disclosure in conjunction with the detailed description of embodiments that follows, and the disclosure is not to be construed as limited to what is shown in such drawings. In the drawings:

FIG. 1 is a sectional view showing a secondary battery according to one or more embodiments.

FIG. 2a is a partially dismantled perspective view showing the secondary battery according to one or more embodiments.

FIG. 2b is a dismantled perspective view showing a state in which an electrode plate and a tab are coupled.

FIGS. 3 to 6 are perspective views the electrode assemblies of the secondary batteries according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be located in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to one or more embodiments will be described with reference to the drawings.

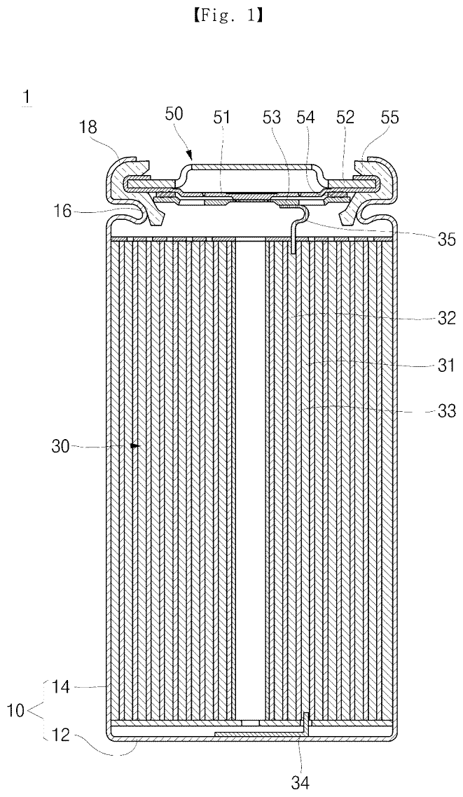

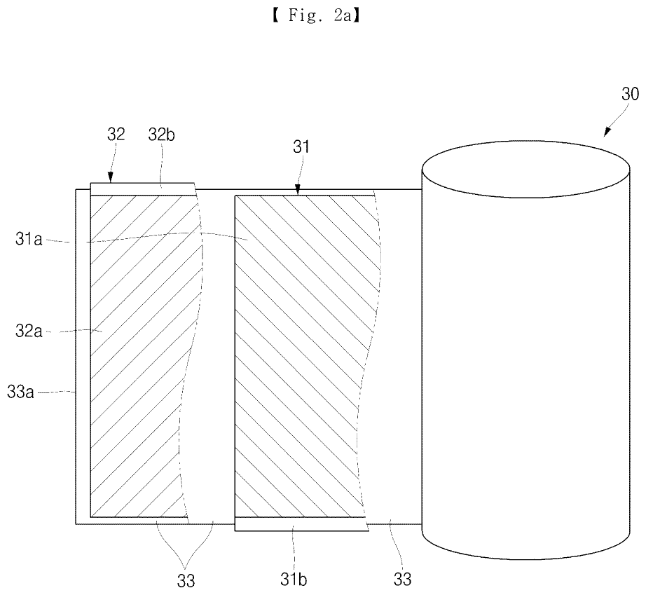

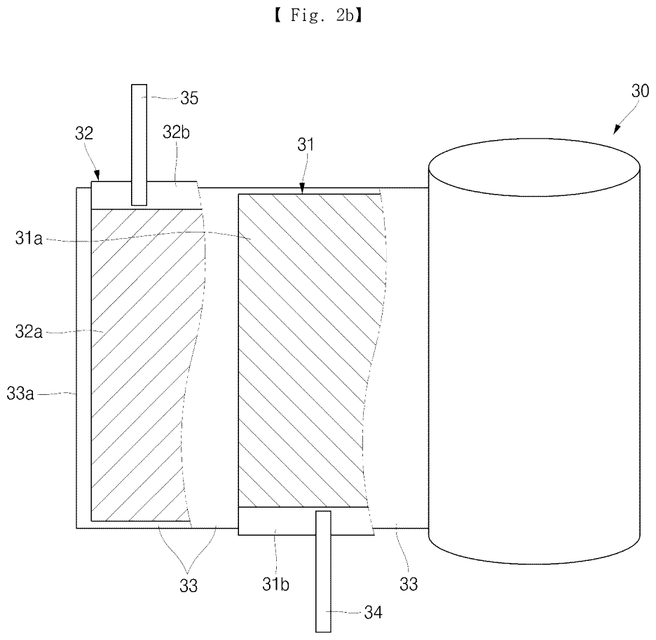

FIG. 1 is a sectional view showing a secondary battery according to one or more embodiments. FIG. 2a is a partially dismantled perspective view showing the secondary battery according to one or more embodiments. FIG. 2b is a dismantled perspective view showing a state in which an electrode plate and a tab are coupled.

Referring to FIGS. 1, 2a, and 2b, the secondary battery 1 according to one or more embodiments may include a cylindrical case 10, an electrode assembly 30, and a cap assembly 50 for sealing the case 10. One end of the case 10 in the longitudinal direction is opened.

The case 10 may include a bottom part 12 and a side part 14. The bottom part 12 may be circular. The side part 14 may extend upwardly from the bottom part 12. The side part 14 is opened. During the manufacturing process of the secondary battery, the electrode assembly, and the electrolyte are accommodated in the case 10 through the opening of the case 10. The case may include steel, a steel alloy, nickel plated steel, nickel plated steel, aluminum, aluminum alloy, or an equivalent thereof.

A beading part 16 and a crimping part 18 are located on the side part 14. The cap assembly 50 may be fixed by the beading part 16 and the crimping part 18. The side part 14 may be bent concavely toward the inside of the case 10, and the beading part 16 may be formed. When the cap assembly 50 is assembled, the cap assembly 50 is supported by the beading part 16. After the cap assembly 50 is assembled, the end of the side part 14 may be bent toward the inside of the case 10, and the crimping part 18 may be formed. The cap assembly 50 may be fixed by the crimping part 18. The crimping part 18 and the electrode assembly 30 may be spaced apart from each other. In one or more embodiments, the crimping part 18 and the electrode assembly 30 are not in contact with each other.

The electrode assembly 30 may include a negative electrode plate 31 coated with a negative electrode active material (e.g., graphite, carbon, etc.) on a negative electrode current collector plate, a positive electrode plate 32 coated with a positive electrode active material (e.g., a transition metal oxide, such as LiCoO₂, LiNiO₂, LiMn₂O₄, etc.) on a positive electrode current collector plate, and a separator 33 positioned between the negative electrode plate 31 and the positive electrode plate 32 to reduce or prevent the likelihood of a short circuit therebetween while allowing the movement of lithium ions therethrough.

The negative electrode plate 31 may be a copper (Cu) or nickel (Ni) foil. The positive electrode plate 32 may be an aluminum (Al) foil. The separator 33 may be polyethylene (PE) or polypropylene (PP).

The negative electrode plate 31 may include a coating part 31a coated with the negative electrode active material, and an uncoated part 31b on which the negative electrode active material is not coated. The positive electrode plate 32 may include a coating part 32a coated with the positive electrode active material, and an uncoated part 32b on which the positive electrode active material is not coated.

A negative electrode tab 34 protruding downwardly to a corresponding length (e.g., predetermined length) may be welded to the uncoated part 31b of the negative electrode plate 31. Also, a positive electrode tab 35 protruding upwardly to a corresponding length (e.g., predetermined length) may be welded to the uncoated part 32b of the positive electrode plate 32. The negative electrode tab 34 may be welded to the bottom part 12 of the case 10. The positive electrode tab 35 may be welded to the cap assembly 50. The case 10 may be a negative electrode, and the cap assembly 50 may be a positive electrode. However, embodiments are not limited thereto. The tabs 34 and 35 might not be coupled to the uncoated parts 31b and 32b. The uncoated parts 31b and 32b may protrude upwardly or downwardly. The uncoated parts 31b and 32b may be electrically connected to the cap assembly 50 and the case 10 through a separate current collecting plate.

The negative electrode plate 31, the positive electrode plate 32, and the separator 33 may be wound in a cylindrical shape, and the electrode assembly 30 is formed. The electrode assembly may be accommodated in the case 10. In this case, the winding end of the outer surface of the electrode assembly 30 should not be unwound. The structure for this is described below.

The cap assembly 50 may include a safety vent 51, a cap up 52, and a cap down 53. The cap up 52 may be located on the safety vent 51. The cap down 53 may be located under the safety vent 51. In one or more embodiments, the cap assembly 50 may further include an insulating member 54 and an insulating gasket 55. The insulating member 54 may be located between the safety vent 51 and the cap down 53. A portion of the safety vent 51, other than the central portion thereof, does not contact the cap down 53. The cap assembly 50 and the case 10 may be insulated by the insulating gasket 55. A central portion of the safety vent 51 may contact the cap down 53. A portion of the safety vent 51 supported by the insulating member 54 may be spaced apart from the cap down 53. A notch may be formed in the safety vent 51. When the internal pressure of the case 10 is increased to more than or equal to a corresponding pressure (e.g., predetermined pressure), the notch may be broken, and gas may be discharged.

Hereinafter, the electrode assembly of the secondary battery according to one or more embodiments will be described in detail.

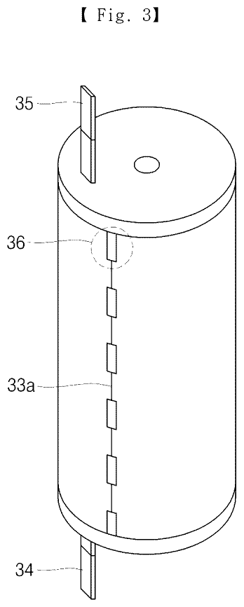

FIG. 3 is perspective view the electrode assemblies of the secondary battery according to one or more embodiments.

Referring to FIG. 3, the electrode assembly 30 may be wound. For example, an end portion 33a of the separator 33 may be located at an outermost portion of the electrode assembly. In one or more embodiments, the separator 33 may form an outer surface of the electrode assembly 30.

The end portion 33a may be a portion where winding is completed. When the end portion 33a is not fixed, the electrode assembly may be unwound. Thus, the end portion 33a may be adhered. For example, the end portion 33a may be adhered along a line (height direction of electrode assembly) of the end portion 33a. Thus, the likelihood of the end portion 33a being unwound may be reduced or prevented.

For example, the end portion 33a may be thermally fused. For example, the end portion 33a may be fused by contacting a bar-shaped heater. In one or more embodiments, the end portion 33a may be bonded by an adhesive. For example, the end portion 33a may be bonded by a plurality of adhesive parts 36. A plurality of adhesive parts 36 may be spaced apart from each other. A plurality of adhesive parts 36 may be formed in a pattern. In one or more embodiments, it is possible to reduce or prevent the likelihood of the end portion 33a being unwound. Also, even if a partial area of the end portion 33a is deformed, it may be suitably bonded. Also, even if any adhesive part is defective, the end portion 33a may be bonded by other adhesive parts. In one or more embodiments, the wound shape of the electrode assembly 30 may be maintained.

The end portion 33a may be fixed to the outermost portion of the electrode assembly 30 by the adhesive part 36. The electrode assembly 30 does not require a separate sealing (or finishing) tape. Stress due to a material difference (for example, a difference in elongation) between the separator 33 and the sealing tape may be prevented or reduced.

In one or more embodiments, the sealing tape is continuously bonded along the end. However, the end of the separator according to one or more embodiments is thermally fused. In one or more embodiments, the end is bonded by a plurality of adhesive parts 36. In one or more embodiments, even if the swelling of the electrode assembly 30 occurs, the internal stress caused by the sealing tape may be reduced.

Hereinafter, a secondary battery according to one or more other embodiments will be described.

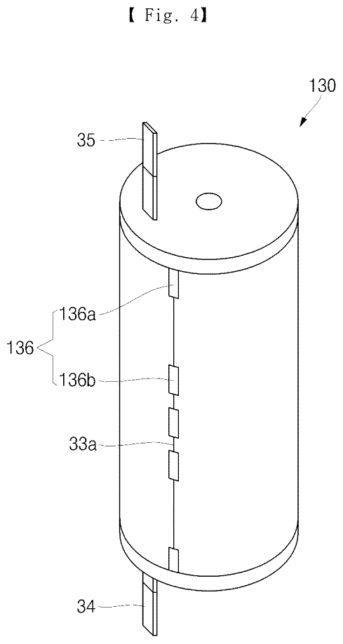

FIG. 4 is perspective view the electrode assemblies of the secondary battery according to one or more other embodiments.

Referring to FIG. 4, the end portion 33a of the separator may be located at an outermost portion of the electrode assembly 130.

The end portion 33a may be adhered. The end portion 33a may be selectively adhered. For example, the end portion 33a may be adhered only to an area that may be relatively easily unwound. For example, the end portion 33a may be thermally fused. For example, the end portion 33a may be fused by contacting a bar-shaped heater. In one or more embodiments, the end portion 33a may be bonded through the adhesive.

The adhesive part 136 may be formed. The adhesive part 136 may include a first adhesive part 136a and a second adhesive part 136b. The first adhesive part 136a is located on the upper end and the lower end of the electrode assembly 130. The second adhesive part 136b is located between the upper end and the lower end of the electrode assembly 130.

The end portion 33a may be relatively easily unwound from the upper and lower ends of the electrode assembly. In one or more embodiments, the first adhesive part 136a is located at the upper and lower ends of the electrode assembly 130.

The second adhesive part 136b may be located in the middle portion of the electrode assembly 130. The second adhesive part 136b may be formed in a plurality of patterns spaced apart from each other. The second adhesive part 136b may be spaced apart from the first adhesive part 136a. The second adhesive part 136b may adhere only a minor or minimum area, such that the end portion 33a is not unwound.

While the adhesive part 136 is formed to have a relatively minor or minimum area, the likelihood of the end portion 33a being released may be reduced or prevented.

Hereinafter, a secondary battery according to one or more other embodiments will be described.

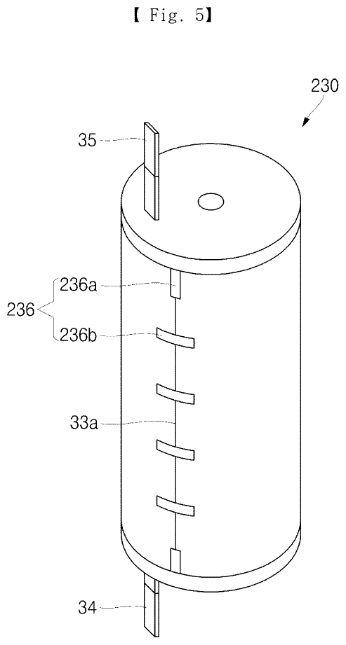

FIG. 5 is perspective view the electrode assemblies of the secondary battery according to one or more other embodiments.

The electrode assembly 230 may include the adhesive part 236. The adhesive part 236 may adhere the end portion 33a of the separator located on an outermost surface of the electrode assembly. For example, the end portion 33a may be thermally fused. For example, the end portion 33a may be fused by contacting a bar-shaped heater. In one or more embodiments, the end portion 33a may be bonded through an adhesive.

The adhesive part 236 may include a first adhesive part 236a and a second adhesive part 236b. The first adhesive part 236a may be located on the upper end and the lower end of the electrode assembly 230. The second adhesive part 236b may be located between the upper end and the lower end of the electrode assembly 230. The second adhesive part 236b may include a plurality of adhesive parts spaced apart from each other.

The end portion 33a may be relatively easily unwound from the upper and lower ends of the electrode assembly. In one or more embodiments, the first adhesive part 236a is located at the upper and lower ends of the electrode assembly 130.

The second adhesive part 236b may be located in the middle portion of the electrode assembly 130. The second adhesive part 236b may be formed in a plurality of patterns spaced apart from each other. The second adhesive part 236b may extend in a direction substantially perpendicular to the extending direction of the end portion 33a. For example, the extending direction of the second adhesive part 236b may be a vertical direction of the extending direction of the first adhesive part 236a. The end portion 33a may be relatively widely adhered to the vertical direction of the end portion 33a by the second adhesive part 236b. The likelihood of the end portion 33a being released may be reduced or prevented.

Hereinafter, a secondary battery according to one or more other embodiments will be described.

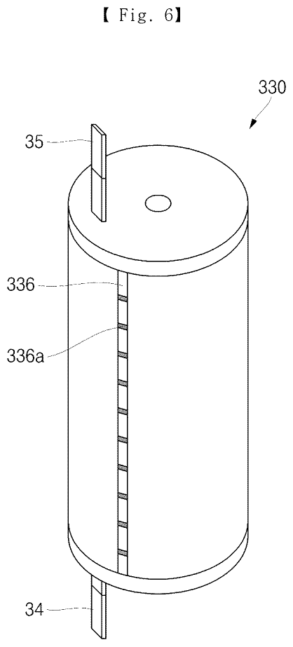

FIG. 6 is perspective view the electrode assemblies of the secondary battery according to one or more other embodiments.

The electrode assembly 330 may include the adhesive part 336. The adhesive part 336 may adhere the end portion 33a of the separator located on an outermost surface of the electrode assembly. For example, the end portion 33a may be thermally fused. For example, the end portion 33a may be fused by contacting a bar-shaped heater. In one or more embodiments, the end portion 33a may be bonded through an adhesive.

The adhesive part 336 may be continuously formed along the end portion 33a. The adhesive part 336 may be formed along the extending direction of the end portion 33a. Also, adjacent adhesive parts 336 may overlap each other. The adhesive part 336 may include an overlapping region 336a. The adhesive part 336 may be formed on the entire end portion by the overlapping region 336a. The likelihood of the end portion 33a being unwound may be reduced or prevented.

The secondary battery according to one or more embodiments includes adhesive part. The adhesive part is formed by a fusion or bonding process. The adhesive part is formed in a plurality of patterns. In one or more embodiments, it is possible to reduce or prevent the likelihood of the winding end of the electrode assembly being unwound. The winding end may be fixed by the adhesive part. The secondary battery according to one or more embodiments may reduce or prevent internal stress generated by the sealing tape.

The above are only some embodiments for implementing a secondary battery according to the disclosure, the disclosure is not limited to the above, and there is a technical spirit of the disclosure to the extent that various modifications can be made by anyone having ordinary skill in the art to which the disclosure pertains without departing from the gist of the disclosure as claimed in the following claims, with functional equivalents thereof to be included therein.

What is claimed is:

1. A secondary battery comprising:
a case defining a space therein;
an electrode assembly in the case and comprising a positive electrode plate, a negative electrode plate, and a separator wound in a cylindrical shape, and an adhesive part adhering and fixing a winding end of an outermost surface of the electrode assembly; and
a cap assembly sealing the case.

2. The secondary battery as claimed in claim 1, wherein the adhesive part is along a boundary line of the winding end.

3. The secondary battery as claimed in claim 1, wherein the adhesive part comprises patterns spaced apart or a continuous pattern.

4. The secondary battery as claimed in claim 1, wherein the separator is at an outermost part of the electrode assembly, and
wherein the adhesive part is along an end of the separator.

5. The secondary battery as claimed in claim 1, wherein the adhesive part comprises patterns at equal intervals.

6. The secondary battery as claimed in claim 1, wherein the adhesive part comprises patterns with a same length.

7. The secondary battery as claimed in claim 1, wherein the adhesive part is fixed to the outermost surface by fusion or bonding.

8. The secondary battery as claimed in claim 1, wherein the adhesive part is fixed to the outermost surface by heat fusion.

9. The secondary battery as claimed in claim 1, wherein the adhesive part comprises first adhesive parts respectively at a top and at a bottom of the electrode assembly, and a second adhesive part between the first adhesive parts.

10. The secondary battery as claimed in claim 9, wherein the second adhesive part extends along an extending direction of the winding end, and
wherein the second adhesive part is in a same direction as the first adhesive parts, or in a direction substantially perpendicular to the first adhesive parts.
